(19) United States
(12) Patent Application Publication
(10) Pub. No.: US 2006/0056852 A1
(43) Pub. Date: Mar. 16, 2006

(54) Method of optical transmission between a terminal onboard a spacecraft and a remote terminal, and spacecraft suitable for such a method

(76) Inventor: Vincent Cazaubel, Toulouse (FR)

Correspondence Address: STURM & FIX LLP, 206 SIXTH AVENUE, SUITE 1213, DES MOINES, IA, 50309-4076, US

(21) Appl. No.: 11/223,582

(22) Filed: Sep. 9, 2005

(30) Foreign Application Priority Data
Sep. 13, 2004 (FR) 04 09691

(51) Int. Cl. H04B 10/00

(52) U.S. Cl. 398/122

(57) ABSTRACT

An optical transmission terminal onboard a spacecraft has a transmission field fixedly oriented relative to a main platform of the spacecraft. During an optical transmission between the onboard terminal and a terminal remote from said spacecraft, the onboard terminal is pointed toward the remote terminal by rotating the main platform of the spacecraft.

### TECHNICAL FIELD

The present invention relates to a method of optical transmission between a terminal onboard a spacecraft and a remote terminal, and also to a spacecraft suitable for implementing such a method.

### BACKGROUND OF THE INVENTION

It is known to use an optical transmission mode to establish a communication link with a device onboard a satellite. Such optical transmissions are used, for example, for communications between satellites orbiting within the same orbit or different orbits, between a satellite and a ground terminal, or between a satellite and an aircraft, for example. This is because an optical transmission terminal consumes very little energy, this being particularly advantageous when this terminal is onboard a satellite.

Now, the radiation beam used for an optical transmission has a very low divergence. It is consequently necessary to point two optical transmission terminals very precisely with respect to each other so as to successfully establish a communication link. To do this, an optical transmission terminal designed to be onboard a satellite comprises several components connected according to the diagram shown in FIG. 1. The terminal thus comprises, in an external part 120 of said terminal, an optical transmission telescope 110, mechanisms 111 and 112 for pointing the telescope 110, an electronic module 113 called a proximity module, and an acquisition and tracking detector 114. These components 110-114 are connected so as to form a feedback control loop for pointing the telescope 110 toward a remote terminal. The terminal further includes two electronic modules 121 and 122 designed to control the optical transmission terminal and to control the communication system, respectively. The modules 121 and 122 are placed in a stationary part 130 of the satellite. The components denoted C in FIG. 1 are optical collimators that form optical interfaces between two components of the terminal, or between a component and an optical fiber.

The mechanisms 111 and 112 respectively form, with the associated control circuits integrated into the module 113, a coarse pointing assembly or CPA and a fine pointing assembly or FPA, respectively. During communication with a remote terminal, the transmission field of the onboard terminal is oriented relative to the satellite by means of the coarse pointing assembly so that the remote terminal remains located within this transmission field. The transmission direction is also adjusted within the transmission field by means of the fine pointing assembly.

The coarse pointing mechanism 111 may be of various forms. In particular, it may be an articulated periscope, a two-axis mechanism for moving an optical head, a mechanism based on a steerable output mirror that can be oriented in azimuth and in elevation, a Coude telescope, etc.

The coarse pointing mechanism has moving parts, such as for example an output mirror with its mount, the size of which corresponds to the output aperture of the terminal. In certain mechanisms, the optical transmission terminal itself is capable of moving, especially when it is placed on a secondary platform of the satellite, which can be oriented relative to the main platform. In all cases, the moving parts of the coarse pointing mechanism are bulky and heavy, and as a consequence their use onboard a satellite is particularly disadvantageous.

Furthermore, the dimensions and the weight of the moving parts of these coarse pointing mechanisms require, in order to orient or move them, actuators of sufficient size and power to be provided. These actuators are therefore themselves heavy and bulky. Furthermore, they consume energy in proportion to their power.

Therefore, it is an object of the present invention to propose an optical transmission method which is suitable for establishing a communication with a spacecraft and which, in particular, does not have the abovementioned drawbacks.

### SUMMARY OF THE INVENTION

To achieve this, the invention proposes a method of optical transmission between a terminal onboard a spacecraft and a terminal remote from said spacecraft, whereby the onboard terminal has a transmission field fixedly oriented relative to the main platform of the spacecraft and whereby said onboard terminal is pointed toward said remote terminal by rotating said main platform of the spacecraft.

Within the context of the invention, the expression “transmission field of an optical terminal” is understood to mean the region of space lying outside this terminal for which an optical signal, which is produced in this region of space, can be detected by said terminal, and for which an optical signal sent by this terminal can be received at any point in said region of space.

Thus, according to the invention, the transmission field of the optical terminal onboard the spacecraft is fixed relative to the main platform of the spacecraft. No coarse pointing assembly is therefore used to orient, relative to the main platform, the transmission field of the onboard terminal toward the remote terminal. The load onboard the spacecraft is therefore reduced, thereby helping to reduce the cost of launching the spacecraft and/or placing it in orbit.

The pointing of the onboard terminal towards the remote terminal is achieved by rotationally orienting the main platform of the spacecraft. In the jargon of those skilled in the art, this pointing is achieved by adapting the attitude of the spacecraft with respect to the relative positions of the onboard terminal and the remote terminal. The means used to change the attitude of the spacecraft therefore also have the function of orienting the transmission field of the onboard optical terminal.

Advantageously, the main platform of the spacecraft is oriented by means of at least one gyroscopic actuator in order to point the onboard terminal toward the remote terminal. Sufficiently precise pointing can thus be achieved, easily and quickly, thanks to the fineness with which the spacecraft can be oriented, this being achieved by maneuvers performed using one or more gyroscopic actuators.

According to the preferred method of implementing the invention, the onboard terminal comprises a telescope and a fine pointing device designed to move an image of the remote terminal in a focal plane of the telescope. A transmission direction can therefore furthermore be adjusted within the transmission field of the onboard terminal, by means of the fine pointing device. By using such a fine pointing device, a particularly reliable optical transmission can be established between the two terminals over a transmission distance that may be very great, for example several tens of thousands of kilometers.

In an improvement of this method of implementing the invention, displacements, in the focal plane of the telescope, of the image of a beam received during an optical transmission in progress, are used to control the pointing of the onboard terminal toward the remote terminal.

The invention also relates to a spacecraft comprising a main platform and an onboard optical transmission terminal, said onboard terminal having a transmission field fixedly oriented relative to the main platform. The spacecraft further includes means for rotationally orienting the main platform, said means being designed to point said onboard terminal toward an optical transmission terminal remote from the spacecraft.

In particular, the means for rotationally orienting the main platform may comprise at least one gyroscopic actuator.

Preferably, the onboard terminal may comprise a telescope and a fine pointing device designed to move an image of the remote terminal in a focal plane of the telescope so as to adjust a transmission direction within the transmission field of said onboard terminal.

The spacecraft may be of various types, including in particular a satellite, whatever the nature of its orbit, or an interplanetary probe.

### BRIEF DESCRIPTION OF THE DRAWINGS

FIG. 1, already described, illustrates the architecture of an optical transmission terminal as known from the prior art;

FIG. 2 illustrates the principle of an optical transmission between two satellites; and

FIG. 3 shows schematically a satellite equipped with an optical transmission terminal used according to the invention.

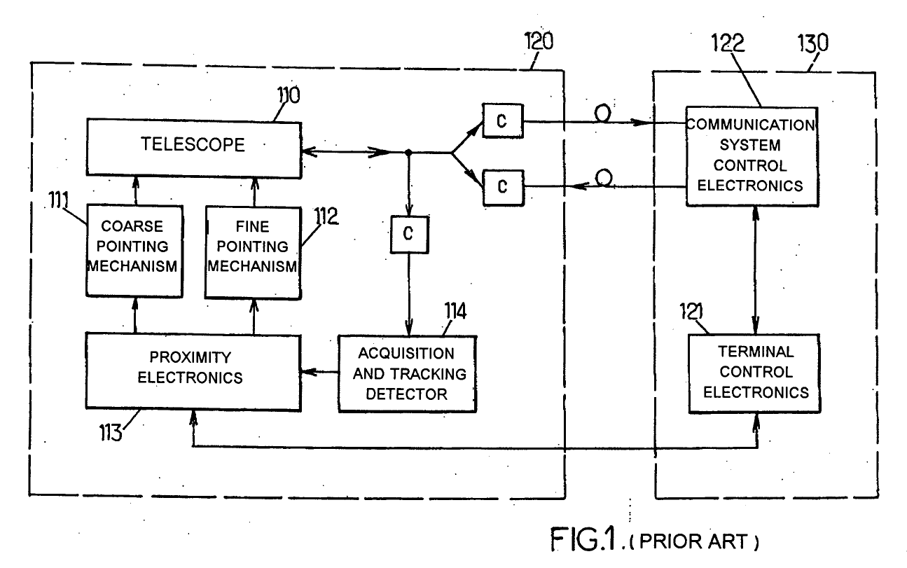

### DESCRIPTION OF A PREFERRED EMBODIMENT

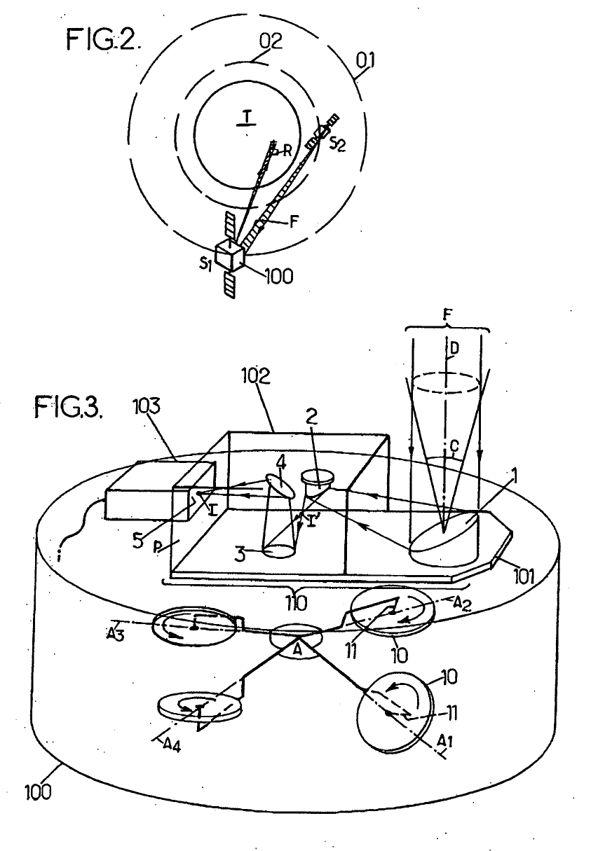

It will be understood that FIGS. 2 and 3 illustrate the principle of the invention in a simplified manner. In particular, for the sake of clarity, all the components of a satellite have not been shown. Furthermore, the dimensions of those parts of the satellite that have been shown are not in proportion with the actual dimensions of those parts.

FIG. 2 illustrates an example of how the invention is applied. A satellite S1, which may be a geostationary satellite, is used to relay data transmitted from a satellite S2 to a ground reception terminal R. The Earth is denoted by T and the orbit of the satellite S1 is denoted by O1. The function of the satellite S2 may be to observe the earth with a high resolution. To do this, it is located on a low-altitude orbit O2 and has a high orbital velocity. The ground terminal R is masked from the satellite S2 by the Earth for approximately half the time, so that a substantial quantity of data cannot be continuously transmitted between the satellite S2 and the terminal R. To increase the duration of transmission between the satellite S2 and the terminal R, the satellite Si is used as transmission relay: the data are transmitted via the satellite S2 to the satellite S1 and then the satellite S1 retransmits the data to the terminal R. The communication between the two satellites can be achieved by an optical-type transmission, to which the present invention applies.

As shown in FIG. 3, the satellite S1 comprises a main platform 100, which may be of parallelepipedal or cylindrical general shape. The platform 100 constitutes the rigid framework of the satellite S1, on which are mounted the motors, the propellant tanks, solar panels, measurement or observation instruments, transmission devices, etc.

An optical transmission terminal is fixed to the platform 100. This terminal comprises a transmission telescope 110, a fine pointing assembly (FPA) and an optical signal transmission/detection unit 103. The terminal may incorporate additional modules, such as collimators, optical coupling components, a filter for cutting off solar radiation, a system for aligning the transmission/detection unit, etc. Such modules are considered as being known to those skilled in the art and, although essential to the operation of the terminal, are not described below.

The telescope 110 comprises a main mirror 1 and second and third mirrors, with references 2 and 3 respectively. The mirrors 1 and 3 are fixed onto a base 101 of the telescope 110 and the mirror 2 is supported by a rigid structure 102, the structure itself being fixed onto the base 101. In a known manner, the mirrors 1 and 3 may be concave and the mirror 2 may be convex. When the terminal operates as a receiver, an incident optical transmission beam, having a parallel beam configuration and denoted by F in FIGS. 2 and 3, is reflected in succession by the mirrors 1, 2 and then 3. An image spot I is thus formed in a focal plane P of the telescope 110. The main mirror 1 constitutes the entrance pupil of the telescope 110: it determines the energy of the optical signal received by limiting the cross-section of a part of the beam F which penetrates the terminal. In one standard configuration of three-mirror telescopes, an intermediate image I′ is formed between the mirrors 2 and 3. The transmission/detection unit 103 possesses an optical signal entry window 5 that is placed in the focal plane P or is optically conjugated with the latter.

When the terminal operates as a transmitter, an optical signal focused onto the window 5 is produced by the transmission/detection unit 103. This signal is converted by the telescope 110 into a parallel beam transmitted into space at the exit of the main mirror 1. The path followed in the telescope 110 by a transmitted optical signal is identical to that of a received optical signal, but being traveled through in the opposite direction.

The mirrors 1, 2 and 3 of the telescope 110 are fixed relative to the base 101 and to the structure 102, and also relative to the platform 100 of the satellite Si. In particular, no moveable system for orienting the telescope 110 is placed between the base 101 and the platform 100. Likewise, no moveable mirror is placed on the outside of the telescope 110 in order to modify, relative to the platform 100, the orientation of the beam F received by the terminal or the orientation of a beam transmitted by the terminal.

The transmission field C of the terminal onboard the satellite S1 is the conical region of space that has the telescope 110 as apex and that contains the directions of transmission associated, via the telescope 110, with image points located within the focal plane P inside the entry window 5 of the transmission/detection unit 103. Consequently, the field C is determined by the relative positions of the mirrors 1-3 and of the transmission/detection unit 103. The field is therefore fixed relative to the platform 100.

Such an optical transmission terminal consequently has no coarse pointing assembly (CPA). This results in a substantial reduction in the weight, bulk and complexity of the optical terminal.

An additional mirror 4, which may be a plane mirror, is furthermore placed in the path of the optical beams inside the telescope 110. The mirror 4 is placed at a real intermediate pupil of the telescope 110, for example at an image of the circumference of the main mirror 1 via the mirrors 2 and 3. The mirror 4 is the active element of the fine pointing assembly (FPA): the mirror 4 is oriented by precise rapid-response actuators so that the transmission direction D at the exit of the telescope 110 remains conjugate at any instant with a central point on the window 5 of the transmission/detection unit 103. Such an FPA system makes it possible to preserve, within the transmission field C, a fixed transmission direction D, by compensating for variations in the orientation of the platform 100, these being due for example to perturbations. As an example, the mirror 4 may be oriented by piezoelectric or magnetic actuators.

Furthermore, the mirror 4 may have the function of folding the beam within the telescope 110, so that the optical terminal is compact.

The satellite S1 further includes a set of gyroscopic actuators or CMGs (Control Moment Gyros). Each gyroscopic actuator allows the satellite to be oriented by rotating the main platform 100 about a defined axis. As shown in FIG. 3, each gyroscopic actuator comprises a wheel 10, or rotor, kept rotating at approximately constant speed about its axis of rotational symmetry 11 by a drive motor (not shown). The wheel 10 is linked to the platform 100 via a gimbal to a shaft, so that it can also be rotated about a secondary axis AA₁ by an attitude motor (not shown). The axis AA₁ lies within the plane of the wheel 10 and is fixed relative to the platform 100. Any rotation of the wheel 10 about the axis AA₁, brought about by the attitude motor, generates, through the gyroscopic effect, a reaction torque on the platform 100, which makes the latter rotate about a defined axis.

Two gyroscopic actuators are sufficient to control the orientation of the satellite about two axes. In practice, at least four gyroscopic actuators are generally used, these being arranged in a cluster in order to ensure three-axes control while guaranteeing redundancy. In FIG. 3, the respective axes AA₁, AA₂, AA₃ and AA₄ of the respective gimbals of the gyroscopic actuators lie along the edges of a square-based pyramid of apex A. Equal angles thus separate two successive gimbal axes on going around the apex A. The arrangement of the gimbal axes may be adapted in a known manner so as to obtain greater orientation sensitivity, or agility, of the platform 100 in certain directions.

Many methods may be used to keep the main platform of a satellite in a defined orientation or attitude. For example, reference directions are located by sensors mounted on the platform, and the respective attitude motors of the gyroscopic actuators are slaved to apparent displacement measurements of the reference directions relative to the platform. Using very precise sensors to measure these apparent displacements, and a fine control mode of the attitude motors, the platform 100 of the satellite S1 can be precisely oriented, sufficiently to orient the transmission field C of the optical terminal during a communication sequence. A stepper control mode of the attitude motors makes it possible in particular to achieve sufficient orientation precision.

Thus, the system for orienting the main platform of the satellite fulfills the function of a coarse pointing assembly (CPA). This additional function assigned to the system for orienting the main platform of the satellite may, according to the invention, be combined in various ways with already known functions, such as that of orienting solar panels, that of orienting a camera or a radiotransmission device, etc. For example, the satellite platform may be placed in succession in different orientations for defined periods, during which the various onboard instruments, which require a suitable orientation of the satellite for them to operate, are activated in succession.

In particular, displacements, in the focal plane P of the telescope 110, of the image I of a beam F received during an optical transmission in progress may be used to control the attitude motors. In this case, the optical communication flux transmitted to the terminal onboard the satellite S1 may include periodic signals for pointing the onboard terminal that are independent of the data signals transmitted.

Many modifications and adaptations of a satellite equipped with an optical transmission terminal as compared with the above detailed description may be introduced. In particular, the number, the arrangement and the control or feedback-control mode of the gyroscopic actuators may be modified. Likewise, a telescope of a type different from that described may be used.

Finally, although the invention has been described in detail in the case of a satellite, it will be understood that it can be applied to all types of spacecraft. In particular, an interplanetary probe may be equipped in a similar manner, so as to establish a transmission link with this probe using the method of the invention.

1. Method of optical transmission between a terminal onboard a spacecraft and a terminal remote from said spacecraft, wherein the onboard terminal has a transmission field fixedly oriented relative to the main platform of the spacecraft, and wherein said onboard terminal is pointed toward said remote terminal by rotating said main platform of the spacecraft.

2. Method according to claim 1, wherein the main platform of the spacecraft is oriented by means of at least one gyroscopic actuator in order to point the onboard terminal toward the remote terminal.

3. Method according to claim 1, wherein the onboard terminal comprises a telescope and a fine pointing device designed to move an image of the remote terminal in a focal plane of the telescope, and wherein a transmission direction is furthermore adjusted within the transmission field of the onboard terminal by means of said fine pointing device.

4. Method according to claim 3, wherein displacements, in the focal plane of the telescope, of the image of a beam received during an optical transmission in progress, are used to control the pointing of the onboard terminal toward the remote terminal.

5. Spacecraft comprising a main platform and an onboard optical transmission terminal, said onboard terminal having a transmission field fixedly oriented relative to the main platform, the spacecraft furthermore including means for rotationally orienting the main platform, said means being designed to point said onboard terminal toward an optical transmission terminal remote from the spacecraft.

6. Spacecraft according to claim 5, wherein said means for rotationally orienting the main platform comprise at least one gyroscopic actuator.

7. Spacecraft according to claim 5, wherein the onboard terminal comprises a telescope and a fine pointing device designed to move an image of the remote terminal in a focal plane of the telescope so as to adjust a transmission direction within the transmission field of said onboard terminal.

8. Spacecraft according to claim 5, comprising a satellite or an interplanetary probe.
